(19) United States
(12) Patent Application Publication
(10) Pub. No.: US 2026/0056099 A1
(43) Pub. Date: Feb. 26, 2026

(54) MATERIAL TESTING MACHINE

(71) Applicant: SHIMADZU CORPORATION, Kyoto-shi (JP)

(72) Inventor: Takayuki AWAZU, Kyoto-shi (JP)

(21) Appl. No.: 19/307,239

(22) Filed: Aug. 22, 2025

(30) Foreign Application Priority Data
Aug. 26, 2024 (JP) 2024-144378

(51) Int. Cl. G01N 3/02; G01N 3/08

(52) U.S. Cl. CPC G01N 3/02; G01N 3/08; G01N 2203/04

(57) ABSTRACT

A material testing machine grips a specimen with three or more substantially horizontally disposed grips and applies a test force to the specimen in a centrally symmetric manner, wherein the material testing machine includes, below the grips, a support member that allows substantially horizontal movement of the grips and restricts substantially vertically downward movement thereof.

### INCORPORATION BY REFERENCE

The present application claims priority under 35 U.S. C. § 119 to Japanese Patent Application No.2024-144378 filed on Aug. 26, 2024. The content of the application is incorporated herein by reference in its entirety.

### TECHNICAL FIELD

The present invention relates to a material testing machine.

### BACKGROUND ART

Patent Literature 1 discloses a material testing machine that grips a specimen with a plurality of substantially horizontally disposed grips and applies a test force to the specimen in a centrally symmetric manner.

Conventionally, in a material testing machine such as that described in Patent Literature 1, a guide rail may be disposed below the grips to prevent the grip portion from tilting forward.

### CITATION LIST

### Patent Literature

[Patent Literature 1] Japanese Unexamined Patent Application Publication (Translation of PCT Application) No. 2016-515718

### SUMMARY OF THE INVENTION

### Technical Problem

However, the configuration of a conventional guide rail becomes a restraining factor for the grips, and there is a risk that resistance will occur during a tensile test. An object of the present invention is to provide a material testing machine that prevents forward tilting of the grips and does not generate resistance during a tensile test.

### Solution to Problem

One aspect of the present invention is a material testing machine that grips a specimen with three or more substantially horizontally disposed grips and applies a test force to the specimen in a centrally symmetric manner, the material testing machine including, below the grips, a support member that allows substantially horizontal movement of the grips and restricts substantially vertically downward movement thereof.

### Advantageous Effects of Invention

According to one aspect of the present invention, forward tilting of the grips of the material testing machine can be prevented, and no resistance is generated during a tensile test.

### BRIEF DESCRIPTION OF THE DRAWINGS

FIG. 1 is a perspective view showing a biaxial tensile testing machine.

FIG. 2 is a cross-sectional view taken along the line II-II of FIG. 1.

FIG. 3 is an enlarged perspective view showing the center of the biaxial tensile testing machine.

FIG. 4 is a plan view showing the grips.

FIG. 5 is a side view showing a grip.

FIG. 6 is a perspective view showing a test stand.

FIG. 7 is a perspective view of a support member.

FIG. 8 is a plan view of the support member.

FIG. 9 is a side view of the support member.

### DESCRIPTION OF EMBODIMENTS

Hereinafter, embodiments of the present invention will be described with reference to the drawings.

1. Embodiment

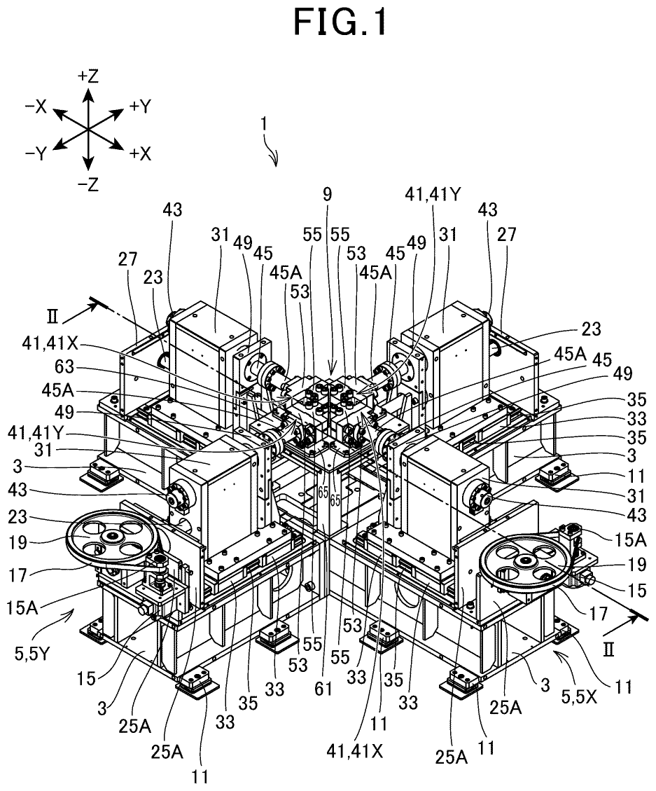

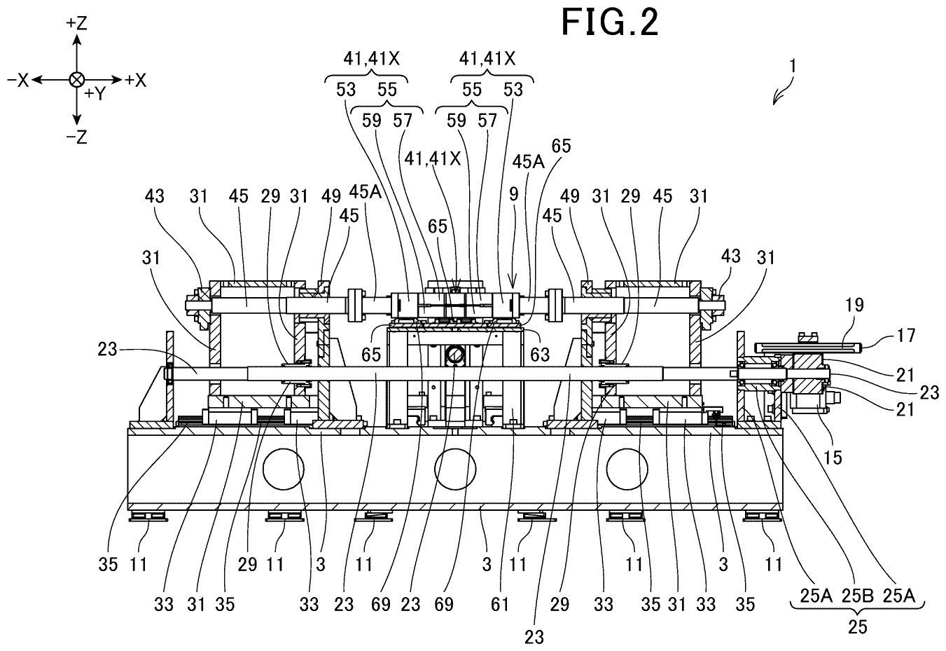

FIG. 1 is a perspective view showing a biaxial tensile testing machine 1. FIG. 2 is a cross-sectional view taken along the line II-II of FIG. 1. The biaxial tensile testing machine 1 is an example of a material testing machine.

Each figure shows the directions of the X-axis, Y-axis, and Z-axis of the biaxial tensile testing machine 1. The X-axis and Y-axis are axes that are orthogonal to each other on a horizontal plane, and the Z-axis is an axis along the vertical direction and is an axis along the height direction of the biaxial tensile testing machine 1.

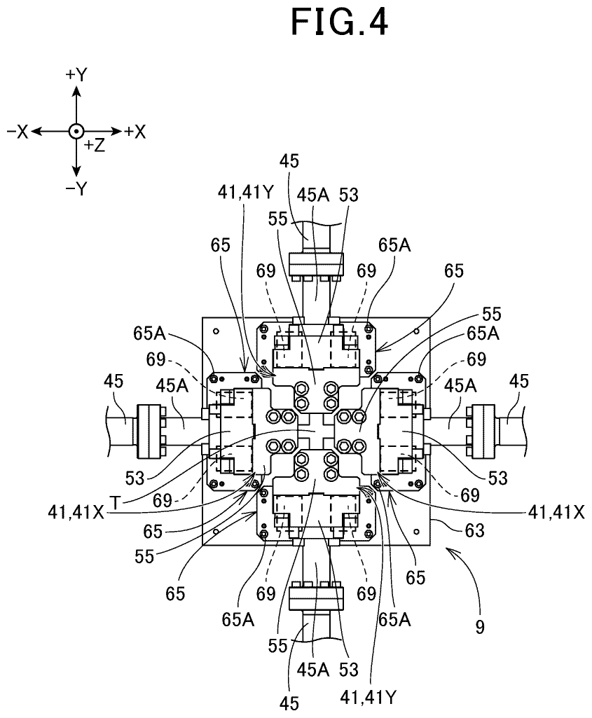

The biaxial tensile testing machine 1 is a material testing machine that performs a test by pulling an X-shaped or cross-shaped specimen T (see FIG. 4) in the X-axis direction and the Y-axis direction. The specimen T is a test body in a biaxial tensile test method. The biaxial tensile test method is, for example, a test compliant with ISO standard 16842. As shown in FIG. 1, the biaxial tensile testing machine 1 includes a base 3, a tensile mechanism 5 supported by the base 3, and a test stand 9 disposed at the center of the base 3. The base 3, formed in an X-shape, includes a plurality of jack portions 11 at its lower part. The height of the base 3 can be adjusted by the jack portions 11.

As the tensile mechanism 5, an X-side tensile mechanism 5X that pulls the specimen T with a similar force in the +X and −X directions, and a Y-side tensile mechanism 5Y that pulls the specimen T with a similar force in the +Y and −Y directions are disposed orthogonally. The biaxial tensile testing machine 1 includes, although not shown, an X-side control device (computer, processor) that controls the X-side tensile mechanism 5X and a Y-side control device (computer, processor) that controls the Y-side tensile mechanism 5Y.

The tensile mechanism 5 includes, at one end, a motor 15, a pulley belt 17, a pulley 19, and a shaft 23.

FIG. 2 is a cross-sectional view showing a plane passing through the shaft 23 extending in the X-direction and extending in the Z-axis direction, as seen from the −Y direction toward the +Y direction.

Referring to FIG. 2, the pulley 19 includes an orthogonal force transmission mechanism 21 at its lower part. The orthogonal force transmission mechanism 21 is meshed with the shaft 23. The orthogonal force transmission mechanism 21 is, for example, a worm wheel and is meshed with a worm formed on the shaft 23. When a motor shaft portion 15A rotates by being driven by the motor 15, the pulley 19 rotates via the pulley belt 17, the orthogonal force transmission mechanism 21 rotates about the Z-axis together with the pulley 19, and accordingly the shaft 23 rotates about its center.

As shown in FIG. 2, one end of the shaft 23 is supported by a shaft support portion 25 disposed adjacent to the motor 15. The shaft support portion 25 includes a pair of vertical plates 25A provided on the base 3 and a cylindrical portion 25B connected between the pair of vertical plates 25A, and the shaft 23 is rotatably supported by the cylindrical portion 25B. The other end of the shaft 23 is supported by a support plate 27 provided on the base 3.

The shaft 23 of the Y-side tensile mechanism 5Y is disposed above the shaft 23 of the X-side tensile mechanism 5X, and the two shafts 23 are disposed so as not to interfere with each other. The X-side tensile mechanism 5X and the Y-side tensile mechanism 5Y are disposed shifted so that the shafts 23 do not interfere, but since the configuration is the same, they will be described collectively as the tensile mechanism 5.

A pair of ball screw nuts 29 are provided on the shaft 23, and the shaft 23 and the pair of ball screw nuts 29 constitute a so-called ball screw mechanism. With the rotation of the shaft 23, the ball screw nut 29 on the motor 15 side and the ball screw nut 29 on the opposite side move on the axis of the shaft 23 in a direction of moving away from each other or approaching each other.

The ball screw nut 29 is connected to a lower part of a housing-like crosshead 31 provided on the base 3, and the ball screw nut 29 and the crosshead 31 move integrally. The crosshead 31 includes a pair of blocks 33 on the side surface of the lower part, and the blocks 33 are fitted into a rail 35 assembled on the base 3. The block 33 and the rail 35 constitute a so-called guide rail mechanism. Hereby, the crosshead 31 can move on the base 3 in the axial direction of the shaft 23.

A rod 45 is inserted through the upper part of the crosshead 31. A connecting rod 45A is connected to the rod 45, and a grip 41 is connected to the tip of the connecting rod 45A. The crosshead 31 includes a load cell 43 connected to the rod 45 on the side opposite to the test stand 9. The load cell 43 is connected to a control device (computer, processor) (not shown) and measures the test force, displacement, etc. at the grip 41.

As shown in FIGS. 1 and 2, the rod 45 is inserted into a rod support portion 49 provided on the base 3, adjacent to the test stand 9 side of the crosshead 31. The rod support portion 49 extends upward from the base 3 in a plate shape, and the rod 45 is inserted into a cylindrical opening at the upper part to support the load of the rod 45. Further, the rod support portion 49 has an opening formed at its lower part so that the shaft 23 can be disposed therein.

Next, the grip 41 provided at the tip of the connecting rod 45A will be described. A connecting portion 53 is connected to the tip of the connecting rod 45A. The connecting portion 53 moves integrally with the crosshead 31 and the rod 45. The grip 41 is connected to the connecting portion 53, and the grip 41 grips and holds the specimen T.

The shaft 23 rotates due to the rotation of the motor 15, and the ball screw nut 29 and the crosshead 31 move integrally, whereby the grip 41 at the tip of the connecting rod 45A moves. The tensile mechanism 5 can pull the specimen T in two coaxial directions by a pair of grips 41 disposed opposite to each other.

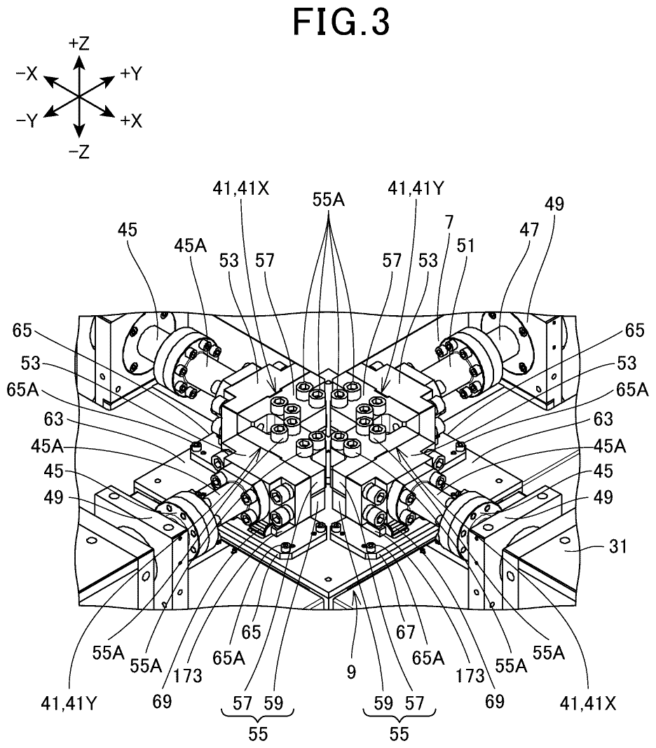

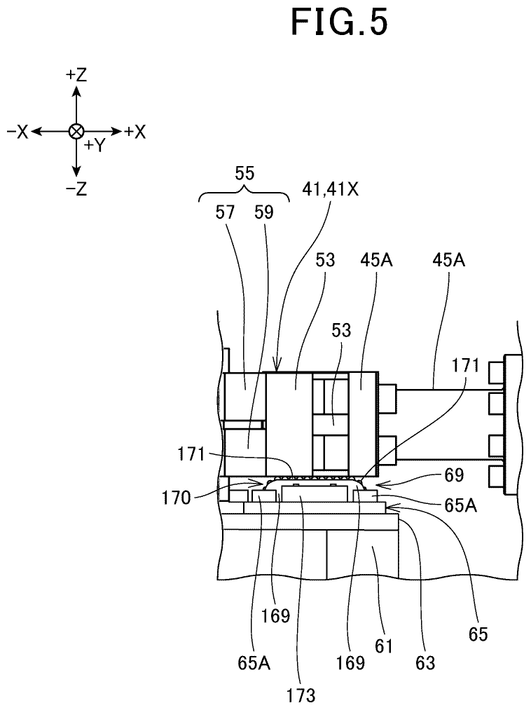

Next, the configuration around the test stand 9 will be described. FIG. 3 is an enlarged perspective view showing the center of the biaxial tensile testing machine 1. FIG. 4 is a plan view from above showing the test stand 9 and the grips 41. FIG. 5 is a side view showing the grip 41 and the support member 69.

As shown in FIG. 3, the grip 41 is divided vertically and includes an upper chuck 57 and a lower chuck 59. By tightening the upper chuck 57 and the lower chuck 59 with a plurality of fasteners 55A, the specimen T is held by the grip 41.

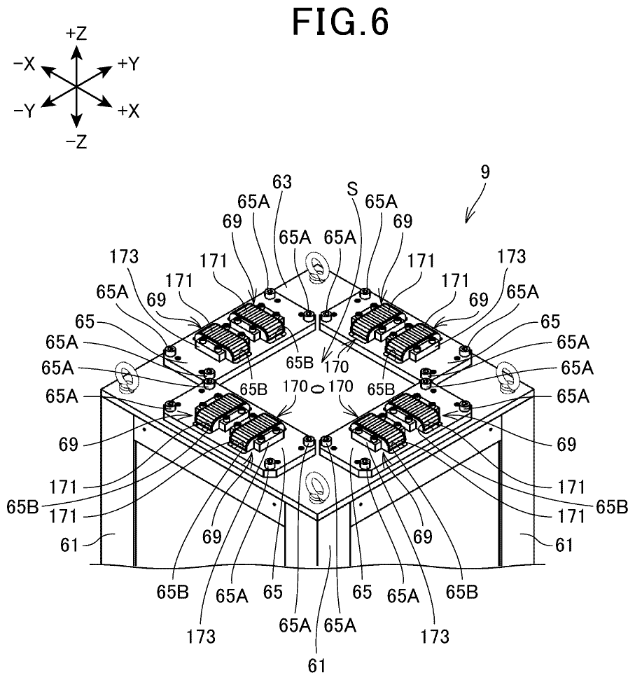

FIG. 6 is a perspective view showing the test stand 9. The test stand 9 includes four support columns 61 extending upward from the base 3, and a pedestal 63 supported on the upper ends of the support columns 61 and having a substantially square shape in a top view.

A flat plate-like plate 65 is fixed to each of the four sides of the pedestal 63 via bolts 65A. The plate 65 has recesses 65B formed at two locations, and a support member 69 is disposed in each recess 65B. As shown in FIG. 5, the support member 69 is located vertically below the grip 41 and restricts the vertically downward movement of the grip 41. The grip 41 is provided at the tip of the connecting rod 45A and is heavy, so it tends to tilt downward under its own weight, but its vertically downward movement is restricted by being supported from below by the support member 69.

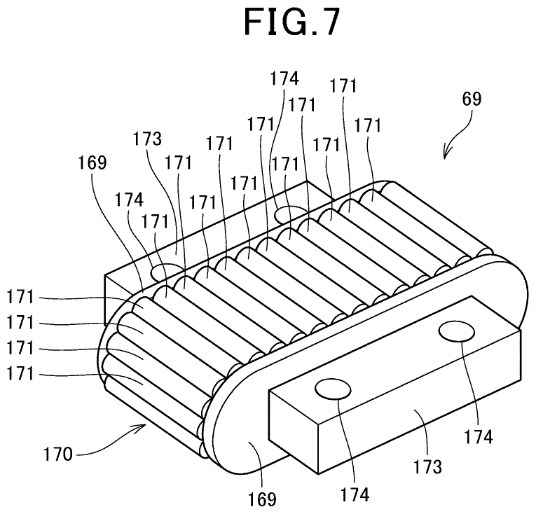

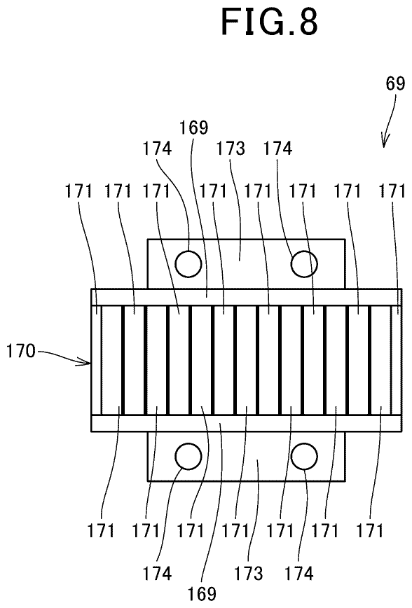

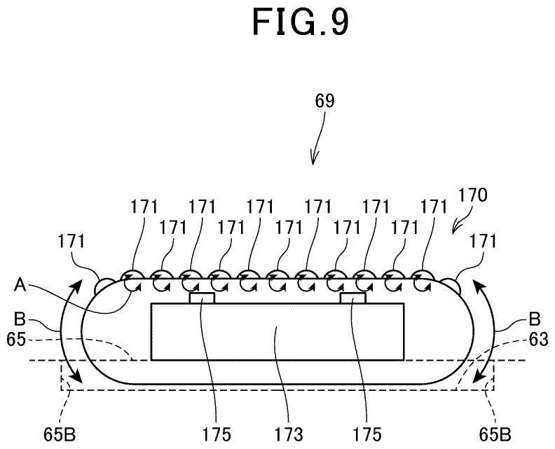

FIG. 7 is a perspective view of the support member 69, FIG. 8 is a plan view of the support member 69, and FIG. 9 is a side view of the support member 69. As shown in FIGS. 7, 8, and 9, the support member 69 includes a pair of side plates 169, an annular movable body 170 supported by the pair of side plates 169, and a plurality of needles 171 rotatably supported on the surface of the movable body 170. The movable body 170 is of a caterpillar type. The needles 171 are disposed with their axes orthogonal to the direction of rotation of the movable body 170. The needles 171 are rotatable in the direction of arrow A in FIG. 9. The movable body 170 is rotatable in the direction of arrow B in FIG. 9. The needle 171 is an example of a rotating member.

A protrusion 173 is attached to the pair of side plates 169. The support member 69 is disposed in the recess 65B of the plate 65 and is fixed to the plate 65 by a fastener 175. The fastener 175 passes through a fixing hole 174 of the protrusion 173 and is fixed to the plate 65.

The support member 69 is a so-called linear roller bearing. The aforementioned grip 41 rests on the upper surface of the support member 69 and moves in the tensile direction. A plurality of needles 171 are exposed on the upper surface of the support member 69, forming a substantially horizontal surface. As the movable body 170 of the support member 69 rotates and the needles 171 further rotate, it is difficult for resistance to be applied to the grip 41 when the grip 41 moves in the tensile direction. The needles 171 function as rollers that facilitate movement in the tensile direction.

As shown in FIGS. 4 and 5, the support member 69 is formed in a rectangular shape having a width in the tensile direction of the grip 41 in a plan view. As shown in FIG. 4, the pair of support members 69 are disposed on one side and the other side in a direction orthogonal to the tensile direction of the grip 41. FIG. 5 shows the grip 41 in the +X direction. As shown in FIG. 5, the majority of the area of the support member 69 mainly abuts the lower surface of the connecting portion 53 of the grip 41 and supports the grip 41 from below. The support member 69 also abuts, for example, the rear end side of the grip 41 and the tip side of the connecting rod 45A as the grip 41 moves.

As shown in FIG. 6, since the plates 65 are attached to the corresponding locations of the pedestal 63, the height can be adjusted corresponding to each of the four grips 41 by adjusting the tightness of the bolts 65A. In addition, the height of the support member 69 provided on the plate 65 creates a margin for a space S that expands in the vertical direction at the center of the pedestal 63 where the specimen T is placed, thereby suppressing a situation where the specimen T interferes with the pedestal 63.

Referring to FIG. 4, the specimen T is pulled in four directions by a pair of first grips 41X that apply a test force in the X-direction and a pair of second grips 41Y that apply a test force in the Y-direction orthogonal to the X-direction. That is, the specimen T is pulled in the X-axis direction and in the Y-axis direction orthogonal to the X-axis direction.

In the present embodiment, the vertically downward movement of the grip 41 is prevented by the support member 69, and it becomes easy to move in the tensile direction. Furthermore, the movement of the grip 41 in a horizontal direction other than the tensile direction is not restricted by the support member 69. Although the movement of the rod 45 to which the grip 41 is connected in a direction other than the tensile direction is restricted by the rod support portion 49 and the like, it can move slightly in the horizontal direction.

Therefore, for example, when the specimen T deforms symmetrically in the +X and −X directions, and the +Y direction is more strained than the −Y direction, the grip 41 does not cancel out the load in the +Y direction. Also, when the specimen T deforms symmetrically in the +Y and −Y directions, and the +X direction is more strained than the −X direction, the grip 41 does not cancel out the load in the +X direction.

In the present embodiment, when the specimen T is gripped by the plurality of grips 41 and a test force is applied to the specimen T in a centrally symmetric manner, there is no restraining factor for the grips 41 as in the conventional art, and while preventing forward tilting of the grips 41, the occurrence of resistance during the tensile test can be suppressed, and the reliability of the result of the tensile test on the specimen T can be improved.

2. Other Embodiments

The above-described embodiments are merely examples of one aspect of the present invention, and can be arbitrarily modified and applied without departing from the spirit of the present invention.

In the above-described embodiments, the biaxial tensile testing machine 1 that pulls the specimen T in two axial directions was exemplified as the material testing machine, but the present invention is not limited to this. In other embodiments, the material testing machine may include three or more grips 41 disposed substantially horizontally, and at least two of the grips 41 may be disposed so that their axial directions are not parallel. Even in this case, the specimen T deforms asymmetrically in a direction different from a certain axial direction, but since the plate 65 as an example of the support member supports the grips 41 of the grip 41 so as to be movable in directions other than the axial direction, the same actions and effects as in the above-described embodiment are achieved. For example, the material testing machine may have a configuration including three grips 41 disposed at an angle of 120 degrees, or may have a configuration including a total of three grips 41, with two parallel grips 41 and one grip 41 in a different direction. Further, the material testing machine may be a multiaxial material testing machine including three or more grips 41.

In the above-described embodiments, the tensile mechanism 5 constituting the ball screw was exemplified as the mechanism for pulling the grip 41 in the axial direction, but the present invention is not limited to this. In other embodiments, the grip 41 may be configured to be pulled by a pulling device such as an actuator.

In the above-described embodiments, a configuration in which the support member 69 is a linear roller bearing was exemplified, but the present invention is not limited to this as long as it does not become a restraining factor in the horizontal direction of the grip 41. In other embodiments, the support member 69 may be a sliding member with reduced frictional resistance. The reduction in frictional resistance is realized by the surface shape of the sliding member, application of a lubricant, or the like. Further, the support member 69 may have a configuration including rotatably provided balls instead of the needles 171. The ball is an example of a rotating member. The support member 69 is not limited to a bearing as long as the portion that abuts the grip 41 is configured to rotate in accordance with the movement of the grip 41.

In the above-described embodiments, the configuration is such that the plate 65 is not disposed in the space S of the pedestal 63 below the specimen T gripped by the grip 41. A predetermined member may be disposed in the space S at the center of the pedestal 63 as long as it does not interfere with the specimen T during the test by the material testing machine.

3. Aspects

It will be understood by those skilled in the art that the plurality of exemplary embodiments described above are specific examples of the following aspects.

### First Aspect

A material testing machine according to one aspect is a material testing machine that grips a specimen with three or more substantially horizontally disposed grips and applies a test force to the specimen in a centrally symmetric manner, wherein the material testing machine includes, below the grips, a support member that allows substantially horizontal movement of the grips and restricts substantially vertically downward movement thereof.

According to the material testing machine of the first aspect, the support member supports the grips from below but does not restrict movement in other directions. Therefore, forward tilting of the grips of the material testing machine can be prevented, and no resistance is generated during a tensile test.

### Second Aspect

In the material testing machine according to the first aspect, the support member includes a pair of side plates, an annular movable body supported by the side plates, and a plurality of rotating members rotatably supported on the surface of the movable body, and the movable body rotates and the rotating members rotate, whereby substantially horizontal movement of the grips is permitted.

According to the material testing machine of the second aspect, the support member does not create resistance to the normal axial movement of the grips. Therefore, the specimen can be pulled without applying unnecessary resistance to the pulling of the grips.

### Third Aspect

In the material testing machine according to the second aspect, the rotating members are needles, and the needles are disposed with their axes orthogonal to the direction of rotation of the movable body.

According to the material testing machine of the third aspect, the needles rotate with the movement of the grips and do not create resistance to the normal axial movement of the grips. Therefore, the specimen can be pulled without applying unnecessary resistance to the pulling of the grips.

### Fourth Aspect

In the material testing machine according to any one of the first to third aspects, the grips include a pair of first grips that apply a test force in an X-direction, and a pair of second grips that apply a test force in a Y-direction orthogonal to the X-direction.

According to the material testing machine of the fourth aspect, the specimen is pulled in another direction orthogonal to one direction. Therefore, a biaxial tensile test method using an X-shaped or cross-shaped specimen can be performed by the material testing machine.

### REFERENCE SIGNS LIST

1 Biaxial tensile testing machine (Material testing machine)

3 Base

5 Tensile mechanism

9 Test stand

11 Jack portion

15 Motor

15A Motor shaft portion

17 Pulley belt

19 Pulley

21 Orthogonal force transmission mechanism

23 Shaft

25 Shaft support portion

25A Vertical plate

25B Cylindrical portion

27 Support plate

29 Ball screw nut

31 Housing

33 Block

35 Rail

41 Grip

41X First grip

41Y Second grip

43 Load cell

45 Rod

53 Connecting portion

55 Chuck

57 Upper chuck

59 Lower chuck

61 Support column

63 Pedestal

65 Plate

69 Support member

169 Side plate

170 Movable body

171 Needle (Rotating member)

173 Protrusion

174 Fixing hole

175 Fastener

S Space

T Specimen

1. A material testing machine for gripping a specimen with three or more substantially horizontally disposed grips and applying a test force to the specimen in a centrally symmetric manner, the material testing machine comprising:
a support member disposed below the grips, the support member allowing substantially horizontal movement of the grips and restricting substantially vertically downward movement thereof.

2. The material testing machine according to claim 1, wherein
the support member includes a pair of side plates, an annular movable body supported by the side plates, and a plurality of rotating members rotatably supported on a surface of the movable body, and
substantially horizontal movement of the grips is permitted by the movable body rotating and the rotating members rotating.

3. The material testing machine according to claim 2, wherein
the rotating members are needles, and the needles are disposed with their axes orthogonal to a rotation direction of the movable body.

4. The material testing machine according to claim 1, wherein
the grips include a pair of first grips that apply a test force in an X-direction, and a pair of second grips that apply a test force in a Y-direction orthogonal to the X-direction.
